(19) United States
(12) Patent Application Publication
(10) Pub. No.: US 2002/0199050 A1
(43) Pub. Date: Dec. 26, 2002

(54) Method and apparatus to select configuration addresses for the peripherals in a computer system

(76) Inventors: Aniruddha P. Joshi, Chandler, AZ (US); Douglas J. Halbert, Chandler, AZ (US)

Correspondence Address: Edwin H. Taylor, Blakely, Sokoloff, Taylor & Zafman LLP, Seventh Floor, 12400 Wilshire Boulevard, Los Angeles, CA, 90025-1030, US

(21) Appl. No.: 09/887,925

(22) Filed: Jun. 22, 2001

(51) Int. Cl. G06F 13/00

(52) U.S. Cl. 710/104

(57) ABSTRACT

In a computer system, each of the peripheral devices are initially in a standby mode and then are powered up into a normal mode, one at a time. A configuration address is assigned to each of the peripheral devices and stored within the device on its initial entrance into the normal mode. This address is used, for instance, to reconfigure the device for context changes. The configuration address remains with the peripheral device until the peripheral device is reset or power is turned on or off.

### BACKGROUND

1. Field of the Invention

The invention relates to peripheral devices in a computer system and their configuration.

2. Prior Art

A typical computer system includes several peripheral devices each having a configuration address. This address is used to select and detect different features or operating modes such as type of device, base address, register address range, first-in-first-out (FIFO) size, direct memory access (DMA) enable, word or byte read/write capability, interface speed, interface width, etc. Most often these features and operating modes are programmable to assure that the peripheral device is compatible with different software applications. The peripheral device configuration address allows the device to change its operating mode and enable/disable features, thus matching the feature set of a particular software application.

Generally, in a computer system, each peripheral device needs a unique configuration address. This permits the application software to be independent of the hardware of the device. For example, in a computer system, the first peripheral device may be assigned configuration address 00, the next peripheral device address 02, the next 04, and so. The problem with peripheral devices is that their configuration addresses are either hard coded or configured through an external pin with additional special hardware circuitry. The configuration address in some devices can be altered through this external pin making it possible to select between two predetermined hard coded addresses by applying a 0 or 1 to the pin. Consequently, peripherals having only two configuration addresses with hard coded values limits the generality of the application software. Additionally, the reuse of application software requires software modifications each time a different peripheral device with a different configuration address is used.

Since only two addresses are hard coded for each peripheral device, only two like peripherals can reside in a computer system, thus limiting the hardware configuration. For example, SIO (super input-output) peripheral devices attached to the low pin count (LPC) bus can choose configuration addresses of either 4E or 2E. In this example, only two SIO peripheral devices can be present in the computer system to avoid address conflicts.

As it will be seen, the present invention solves this problem.

### BRIEF DESCRIPTION OF THE DRAWINGS

FIG. 1 is a block diagram of a computer system which includes peripheral devices in accordance with the present invention.

FIG. 2 is a partial block diagram of a peripheral device for one embodiment of the present invention.

FIG. 3 is a flow diagram illustrating a method described in the present application.

### DETAILED DESCRIPTION

A method and apparatus to select configuration addresses for peripheral devices in a computer system is disclosed. In the following description, well known details associated with computer systems such as normal/standby modes are not described in detail in order not to unnecessarily obscure the present invention. Additionally, while in the following description certain specific embodiments are described, other embodiments will be apparent to one skilled in the art.

As will be seen, the present invention takes advantage of the power level control circuitry found in peripheral devices. This circuitry enables the peripheral device to operate in two modes, a normal (“powerup”) mode and a “standby” mode. These modes are selected by a signal applied to each device through a signal pin or other connection mechanism. Most often, the software application selects either the normal mode or standby mode using a programmable general-purpose output unit. In the normal mode, the peripheral device is generally fully operational and performs read or write commands. In the standby mode, the peripheral device does not respond to any address or command. In effect, the peripheral device is not connected to the system in the standby mode. Each peripheral device receives a separate power level control signal, thereby allowing the selection of only those peripheral devices that are needed at a given time.

With the present invention, when power is turned on from off or reset is applied, a peripheral device switches from the standby mode to the normal mode, the device initially responds to all possible configuration addresses. To select a specific configuration address for a particular peripheral device, the software application writes a pre-selected data pattern at the desired configuration address on the address bus. In response to this data pattern, the device selects as its configuration address, the address used by the software application when the specific data pattern was written. Another alternative is that the peripheral device does not need or use a specific data pattern, rather it uses the first address written to or read from after coming out of the standby mode as the configuration address. Once this pattern is written and the configuration address is selected, the device uses this configuration address space from that point in time. The newly programmed configuration address is not alterable until the system's power is turned off and turned back on or reset is applied. The device responds only to the programmed configuration address or the implied address range and ignores all other addresses.

In operation, when a computer system starts first time (i.e. power is turned on or reset is applied), each device is put in standby mode by the software, by programming appropriate general-purpose output pins of the general-purpose output unit. The software application then sets the first peripheral device, device 1, in normal (powerup) mode with the help of general-purpose output signal, and writes the pre-selected data pattern on the data bus at the address which is to become the peripheral's configuration address. For example, if the address written to the device 1 is a 02, that becomes the configuration address for device 1. Since the other devices are still in the standby mode, those devices ignore the signals on the bus. The software application then selects the second peripheral device, device 2, by powering up device 2 on the appropriate general-purpose output pin. The software then writes another pre-selected data pattern at a different address than the first one, for instance, 04. Device 2 then selects the address 04 as its configuration address. As an example, if there are four peripheral devices in the computer system, the system can select 2E, 4E, 6E, and 8E as the configuration addresses for each device, respectively.

While the discussion above and below centers on the assigning of a single address, this may be looked at as a base address or the starting address of an address range. Implicit in assigning an address, is the assignment of a second, next address. For instance, when 00 is assigned, 01 is implicitly assigned. Two addresses are required for operation of the peripheral device in most instances such as for SIO. Also, while the discussion centers around the assignment of an address, this may be looked at as an address space because of the mapping that typically occurs.

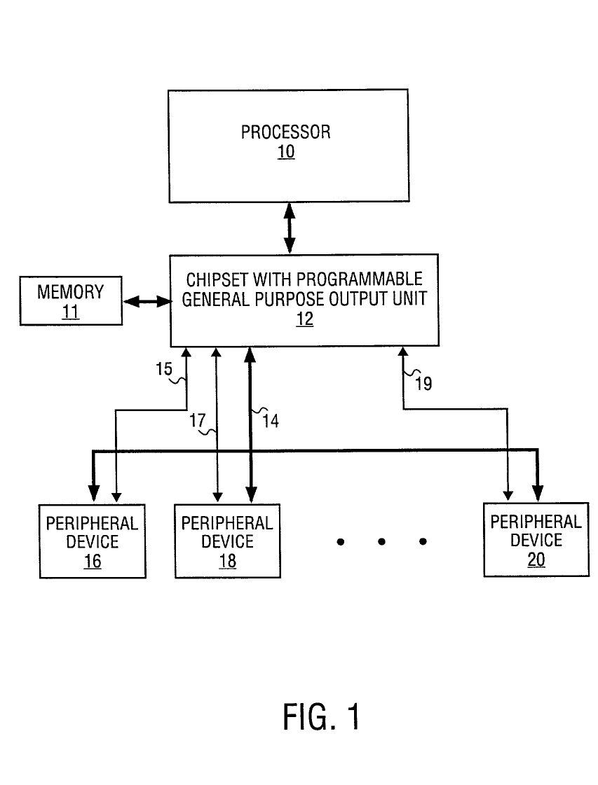

Referring to FIG. 1, a system is shown having a processor 10 which may be, for instance, a commercially available microprocessor, microcontroller or other central processing unit (CPU). This processor communicates over a bus with a chip set which includes a programmable general-purpose output unit 12. A memory 11 such as a dynamic random-access memory (DRAM) 11 is coupled to the unit 12. Another bus 14 which includes address, data and control bus signals is coupled between the unit 12 and each of the peripheral devices 16, 18, and 20. A separate power level control line (normal/standby line) is connected to each of the peripheral devices from the unit 12. For instance, line 15 is connected to device 16, line 17 to device 18 and line 19 to device 20. Each of these lines received a power control signal which enables its respective peripheral device to be in either a standby or normal mode.

As mentioned above and as will be discussed below, the power level control line and its signal are used in the present invention not only to control the power level in the device, but also to enable the initial assignment of a configuration address.

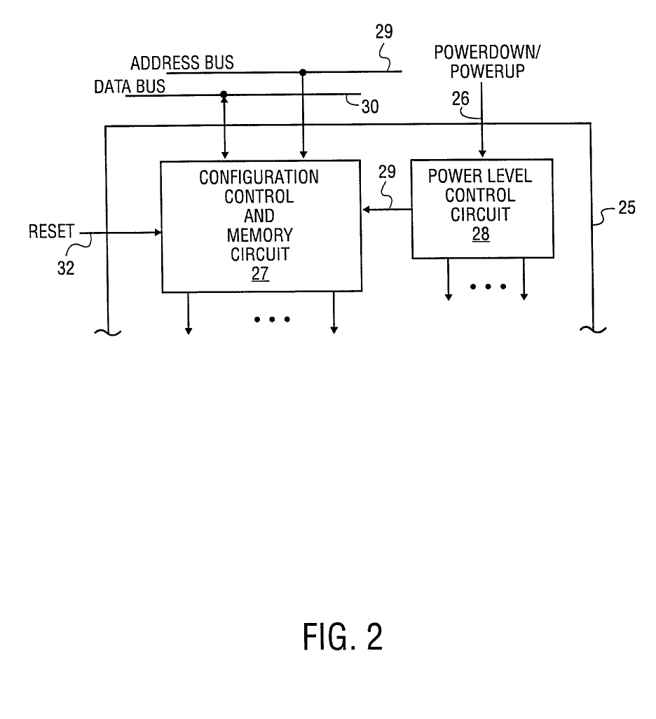

Referring to FIG. 2, a portion of a peripheral device 25 is illustrated. It includes a power level controlled circuit 28, which receives a power level control signal on line 26. The circuit 28 may be an ordinary control circuit such as currently used in numerous peripheral devices to control the power level in the peripheral device. For purposes of the present invention, a signal from this circuit is coupled to the configuration control and memory circuit 27 on line 29. The signal on line 29 indicates when the peripheral device is powered up.

The configuration control and memory circuit 27 of FIG. 2 provides coupling between the address and data buses 29 and 30, respectively and the peripheral device 25. Circuit 27 upon reset (this includes the initial powering up of the computer system) has no assigned configuration address. At the time all the peripheral devices are standby mode or controlled by the power level signals. After a signal is received by a circuit 27 on line 29 indicating that the device has entered the normal (powerup) mode, the circuit 27 is then ready to store its configuration address. The first address from the bus 29 is accepted and defines the configuration address space for the peripheral 25. Once the data from the bus has been accepted and the configuration address space defined, subsequent standby mode or normal mode entry or exit of the peripheral device 25 does not change or erase the configuration address. Until a reset occurs, or the device power is turned off or back on, such as indicated by line 32, the configuration address space remains fixed. When for instance, and application software needs to change operating parameters of the peripheral or a different application software needs to be run, the peripheral device's 25 features can be reconfigured; however, its configuration address remains the same from one application to another.

The programmed configuration address is stored in a latch, register or other memory. The circuit 27 also recognizes the next address (e.g., 01 and 02) as mentioned above, once it is programmed with its configuration address. The memory storing the address is cleared on reset or power turned off.

Once the configuration address has been defined for the peripheral device, the device can be configured for a particular application as is currently done.

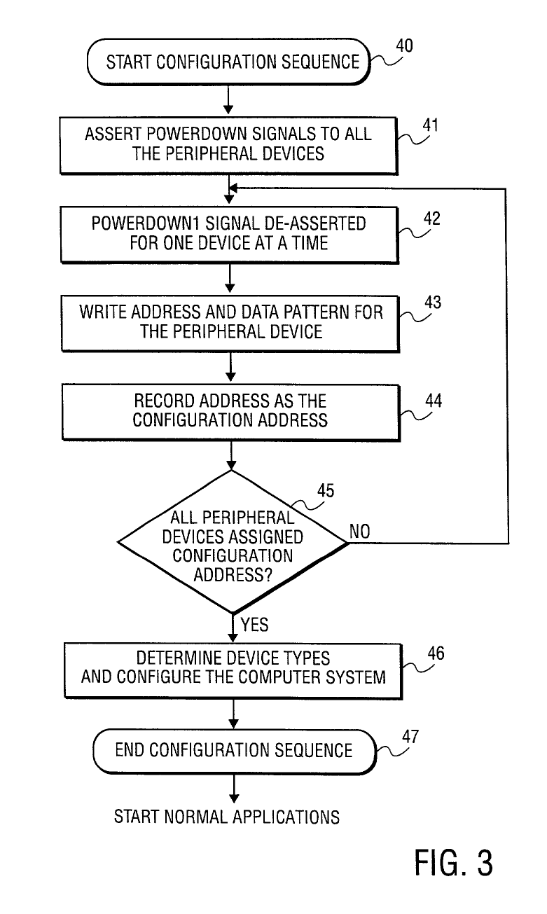

The steps of the present invention are illustrated in FIG. 3. When a computer system is first turned-on or when a reset occurs, the start configuration sequence 40 is initiated. Note, this does not occur on a context change as mentioned above. Once the sequence begins as indicated by step 41, all the peripheral devices are in standby mode by asserting general purpose output signals to all the devices. Then as indicated by step 42, the general purpose output signal is deasserted (device is normal mode) for a first peripheral device. When this occurs, as indicated by step 43, an address is written to that peripheral device. For instance, a pre-determined data pattern is coupled to the device which in interpreted as an address space. Now, as indicated by step 44, this address is recorded, that is, it is stored in memory by the peripheral device. This can be done using a register which remains powered up during the standby mode.

Step 45 is used to determine whether there are peripheral devices remaining that have not been assigned a configuration address. If, for instance, there are three peripheral devices, after the first device is assigned a configuration address, steps 42, 43, and 44 are repeated for device 2, and repeated again for device 3. Thus, steps 42, 43, and 44 are repeated until a unique configuration address has been assigned to each of the peripheral devices. Then, as indicated by step 46, the computer system can determine the characteristics of each of the devices and can configure them as needed for each application. Finally, as indicated by step 47, the configuration sequence is completed and normal application operation can begin.

Thus, a method and apparatus has been described for assigning configuration addresses to peripheral devices.

What is claimed:

1. A computer peripheral device comprising:
a memory for storing a configuration address; and
a power level control circuit for controlling the power level in the device, the circuit being couple to the memory to cause the memory to store the configuration address from a bus when the device enters a normal power mode.

2. The device defined by claim 1 wherein the memory, once storing a configuration address, retains that address until the device is reset or power is turned on or off.

3. The device defined by claim 2 wherein the memory does not change its stored address when the device is reconfigured.

4. The device defined by claim 3 wherein the bus is an address bus.

5. The device defined by claim 4 wherein the memory restores an address after a reset signal is received by the circuit or power is turned on or off.

6. The device defined by claim 5 wherein the circuit is responsive to two addresses once a configuration address is stored.

7. The device defined by claim 1 wherein the memory restores an address after a reset signal is received by the circuit or power is turned on or off.

8. A computer system comprising:
a processor; and
a plurality of peripheral devices coupled to the processor through at least one bus, each device having a power level control circuit and a storage circuit for storing a configuration address, the storage circuit storing a configuration address from the bus when the power level control circuit initially powers up the device in a normal operating mode.

9. The system defined by claim 8 wherein the bus is an address bus.

10. The system defined by claim 8 wherein each of the peripheral devices are initially sequentially brought into a normal operating mode from a standby mode.

11. The system defined by claim 10 wherein the peripheral devices are sequentially powered up after a reset or after power is turned on or off.

12. A computer system comprising:
a processor;
an output unit coupled to the processor; and
a plurality of peripheral devices each being coupled to a bus and each being coupled to a power level control line from the output unit, each peripheral device having a memory which receives and stores a configuration address from the bus in response to a signal on its respective power level control line causing the device to enter a normal operating mode.

13. The system defined by claim 12 wherein the bus is coupled between the output unit and the peripheral devices.

14. The system defined by claim 13 wherein the bus is an address bus.

15. The system defined by claim 12 wherein the memory of each of the peripheral devices store a configuration address only when first entering the normal operating mode after a reset or after power is turned on or off.

16. A method for operating a computer system comprising:
sequentially entering a normal mode from a standby mode for each peripheral device; and
storing a unique configuration address is each device as each enter the normal mode.

17. The method defined by claim 16 wherein the storing step occurs after reset.

18. The method defined by claim 17 wherein the storing step for each peripheral device includes the reading of data from a bus.

19. The method defined by claim 18 wherein the reading of data from a bus comprises the reading of data from an data bus and an address from an address bus.

20. The method defined by claim 18 including configuring each peripheral device after it has stored its configuration address.
